(19) United States
(12) Patent Application Publication
(10) Pub. No.: US 2024/0141924 A1
(43) Pub. Date: May 2, 2024

(54) ASSEMBLY COMPRISING FLUID CONTROL UNITS FOR A MOTOR VEHICLE

(71) Applicants: PSA AUTOMOBILES SA, Poissy (FR); BUEHLER MOTOR GMBH, Nürnberg (DE)

(72) Inventors: Imad-Eddin SABIR, BENI MELLAL (MA); Mathieu ROCHES, PARIS (FR); Harald RAUSCH, Fürth (DE); Martin GUNDERMANN, Nürnberg (DE)

(21) Appl. No.: 18/549,517

(22) PCT Filed: Mar. 3, 2022
(86) PCT No.: PCT/FR2022/050377

§ 371 Date: Sep. 7, 2023

(30) Foreign Application Priority Data
Mar. 11, 2021 (FR) FR2102397

(51) Int. Cl. F04D 29/62; F01P 5/10; F04D 13/14

(52) U.S. Cl. CPC F04D 29/628; F01P 5/10; F04D 13/14

(57) ABSTRACT

Assembly comprising several fluid control units (2) for a motor vehicle, each comprising a body (4) and rotational axes (A) 5 parallel to each other, and comprising a support member for said control units (2) which comprises a plate (20) forming a single part arranged in a plane perpendicular to the axes (A), and having holes passing through said plate (20), each hole receiving a body of a control unit (4).

### CROSS-REFERENCE TO RELATED APPLICATIONS

This application is the US National Stage under 35 USC § 371 of International Application No. PCT/FR2022/050377, filed Mar. 3, 2022, which claims the priority of French application No. 2102397 filed on Mar. 11, 2021, the content (text, drawings and claims) of both said applications being incorporated by reference herein.

### BACKGROUND

The devices described herein relate to an assembly comprising several fluid control units for a motor vehicle, as well as a motor vehicle comprising such an assembly.

Some motor vehicles may comprise at least two control units for controlling a coolant, pumps in particular, each comprising an electric drive having parallel rotational axes, which are attached to the power train in order to manage the heat fluxes of the engine and the transmission.

One known type of assembly with two pumps, presented in particular by document FR-A1-3065511, comprises a first elongated tab, and a second elongated tab attached to the base of this first tab, these tabs made from stamped metal sheet having a constant cross section with two corrugations.

Each pump comprises a housing having a slot of constant section formed in a plane perpendicular to the axial direction, which extends over a length of this housing, receiving one of the tabs of the support member inserted therein with a tight fit.

A problem which arises is that it is difficult to adjust the vibratory isolation between these pumps and the support member, in order to avoid transmissions of vibrations and noise.

Furthermore, this support comprises two metal parts that must be assembled together, requiring the management and supply of these parts, then a time for the assembly of these parts by using a tool which is necessary to tighten this assembly.

These manipulations lead to risks of poor assembly, such as insufficient tightening. The manufacturing, the management of the parts and the necessary assembly time lead to particular costs.

Another type of known assembly with two pumps, presented in particular by document EP-A1-3248821, comprises, for each pump, a plate receiving the body of this pump in a hole, these plates comprising complementary shapes on one side which allow interlocking together in order to connect them so as to secure the two pumps.

One side of each plate comprises a slot that extends axially through this plate, having a constant section. A single fastener comprises two tabs that are inserted into the slots of the two plates of the pumps.

However, the connections between the two plates of the pumps have dimensions that can limit the convergence of these pumps; a relatively large overall size of the assembly is obtained. This assembly is more difficult to install on a power train, in an engine compartment having a generally reduced space to optimize vehicle volumes.

The two plates also constitute two components resulting in manufacturing and supply costs, and requiring time for assembly to one another.

### SUMMARY

The purpose of the devices described herein is in particular to avoid these problems of the prior art.

To this end, it proposes an assembly comprising several motor vehicle pumps, each pump comprising a body and a rotational axis, the rotational axes of each pump being parallel to each other, and comprising a support member for these pumps, this assembly being remarkable in that the support member comprises a plate forming a single part arranged in a plane perpendicular to the axes, comprising holes passing through this plate, each receiving a body of a pump.

One advantage of this assembly is that since the plate forms a single part of the support member, by bringing the holes receiving the bodies of the control units as close together as possible, these bodies may be arranged as close as possible to one another, without having to provide connections of two plate parts to one another. In this way, the bulk of the assembly is reduced, and integration thereof on the vehicle's power train is made easier.

In addition, the connection between the two control units is secured by the single plate receiving them, the number of parts is reduced and the assembly is simplified, which reduces manufacturing costs.

The assembly with control units may further comprise one or more of the following features, which can be combined with one another.

Advantageously, each hole comprises, in a plane transverse to the axes, a section which is constant over the length of this hole.

In this case, advantageously the constant section of each hole forms a circle comprising regularly distributed hollows on the contour.

Advantageously, one face of the plate comprises grooves on the contour of each hole, each receiving a boss protruding from the outer contour of the bodies of the control units.

Advantageously, the plate comprises slots for receiving fasteners which have a constant cross section.

In particular, the plate may comprise three slots spaced apart from one another.

In addition, the slots can form holes that pass through the plate. Advantageously, the plate comprises elastomeric materials.

The plate may in particular comprise several elastomeric materials having different stiffnesses.

The described devices also relate to a motor vehicle comprising at least two coolant pumps that form part of an assembly comprising any one of the preceding features.

### BRIEF DESCRIPTION OF THE FIGURES

The devices will be better understood and other features and advantages will become more clearly apparent on reading the following description given by way of example, with reference to the appended drawings wherein:

FIG. 1 shows a complete assembly comprising two pumps;

FIG. 2 is a view of the front face of only the support plate of this assembly;

FIG. 3 is a view of the rear face of this plate;

FIG. 4 is a view of the rear side of the assembly attached to a power train; and

FIG. 5 shows a complete assembly showing several possible angular orientations of each pump.

### DETAILED DESCRIPTION

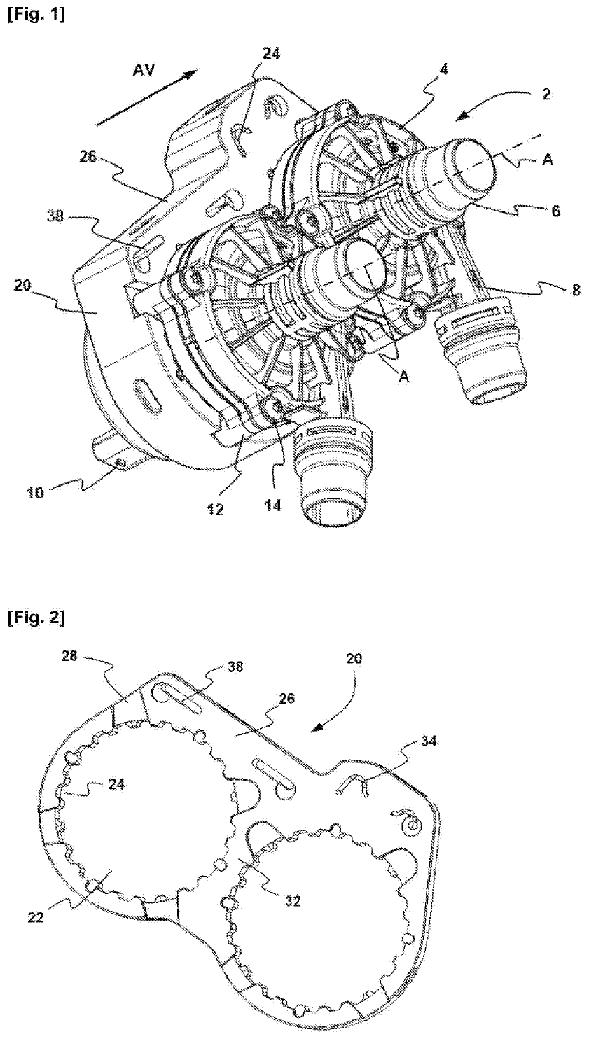

FIG. 1 shows an assembly comprising two control units for controlling the circulation of fluid, in particular pumps 2, each having a rotational axis A, these axes parallel to one another comprising a side conventionally called front side, indicated by the arrow AV.

Each pump 2 comprises an exterior body 4 comprising, on the front face, an axial orifice 6 and a tangential orifice 8 for the circulation of the fluid in this pump.

The rear face of each pump comprises electrical connectors 10 allowing them to be supplied with current on demand, to control the circulation of coolant in a motor vehicle, in particular an electric or hybrid vehicle.

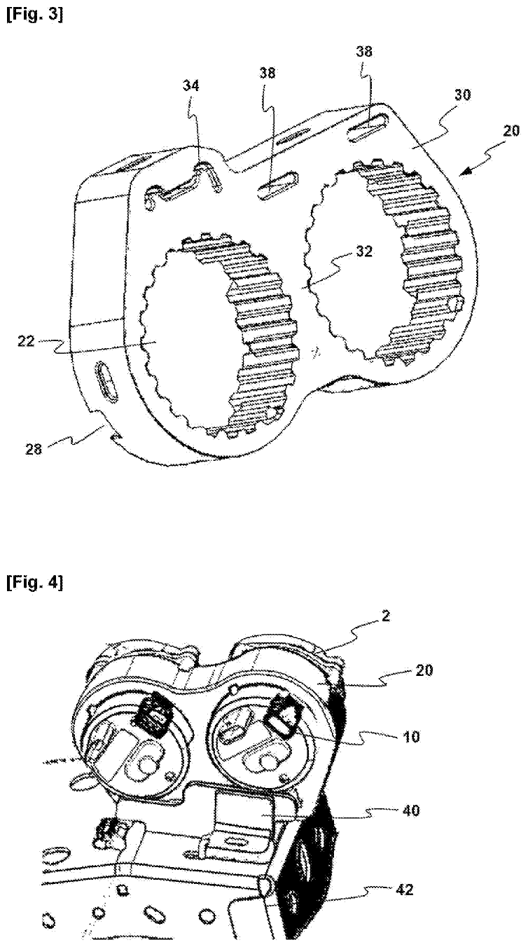

FIGS. 1, 2 and 3 show a support member formed by a single plate 20 with two parallel faces 26, 30 perpendicular to the axes A, comprising two through holes 22 which each receive a pump body 4. The constant section perpendicular to the axes A of each hole 22 forms a circle comprising, on the contour, regularly distributed hollows 24.

The body 4 of each pump 2 comprises a substantially circular contour comprising a series of axial teeth which fit into a hole 22 of the plate 20 so as to perform both centering and alignment of this pump, and blocking in rotation about its axis owing to the teeth wedged in the hollows 24.

Each pump body 4 comprises four bosses 12 which extend axially, protruding from the substantially circular outer contour of this housing, each receiving a screw 14 parallel to the axis A allowing various parts of this body which are axially stacked to be tightened relative to one another.

The front face 26 of the support plate 20 comprises, for each hole 22, four radially oriented grooves 28, distributed around this hole over a small thickness of the plate, each receiving one end of a boss 12 which slightly enters this front face. The ends of the bosses 12 fitted in the grooves 28 also avoid arranging each pump 2 with an incorrect angular orientation in its hole 22.

The two pumps 2 are arranged as close as possible to one another, with a minimum radial distance between their two bodies 4, comprising a reduced material thickness 32 between the two holes of this plate 22. The use of a single plate 20 receiving the two holes 22 avoids providing a connection between two separate support members. In this way, the overall bulk of the assembly is reduced, and it is easier to install it in the engine compartment of the vehicle.

The rear face 30 of the support plate 20 comprises a slot with a curved section 34 having two corrugations, which extends parallel to the axis over a large part of the thickness of this plate, opening partially onto the front face 26.

Two other straight slots 38 spaced apart from one another, and spaced apart from the curved slot 34, each having a straight shape aligned with the other straight slot, pass completely through the thickness of the support plate 20.

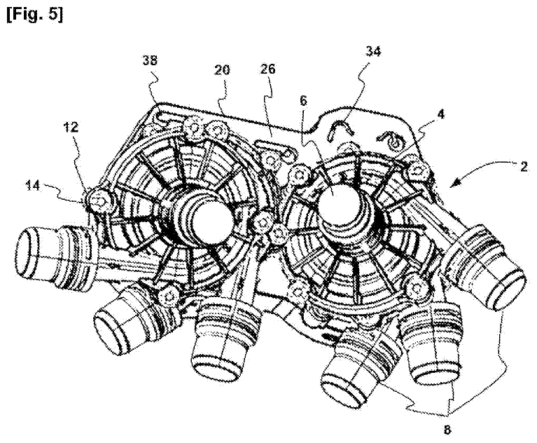

FIG. 4 shows a fastener 40 formed by sheets folded and assembled together, attached to a power train 42, having three elongated tabs parallel to the axes A which each fit in the curved slot 34 or in one of the straight slots 38. The spacing of the slots 34, 38 relative to one another imparts rigidity and limits the stresses in the fastener 40.

In this way, a complete assembly is made comprising the support plate 20 receiving the two pumps 2, which can be prepared for example by a supplier. The complete assembly is then mounted on the vehicle with the aid of the fastener 40 comprising a single part, which simplifies the supply operations, and reduces the risks of incorrect assembly as well as the assembly times on this vehicle.

The support plate 20 is advantageously made by molding a material having a certain flexibility, calculated to dampen the vibrations emitted by the operation of each pump 2, which avoids transmitting these vibrations to the power train and to the body of the vehicle by preventing the propagation of sound.

The flexible material of the support plate 20 also makes it possible to prevent the transmission of vibrations from the power train to the pumps 2, avoiding loosening, in particular of the electrical connections 10.

The support plate 20 may comprise different materials having different hardnesses or stiffnesses, in particular elastomers assembled by successive overmoldings, which make it possible to meet mechanical strength and vibration insulation constraints based on the shapes of the part.

The hardness is linked to the stiffness in the sense that, when the hardness increases, the stiffness also increases accordingly.

For example, a support member 20 can be provided whose interior side, which is in contact with the pump,

is more flexible, which could thus better dampen the vibrations of the pump, while having a peripheral exterior side with a greater stiffness than that of the interior side. Thus, the support member 20 would have a first part made of a first material having a first stiffness surrounding the hole 22 and a second peripheral part surrounding the first part made of a second material having a greater stiffness than that of the first material.

FIG. 5 shows the same support plate 20 comprising holes 22 able to receive the pump bodies 4 in different angular positions owing to the circular contour and to the succession of hollows 24 distributed regularly. This plate 20 forms a standard that can be used on a variety of vehicles.

In this example, three mounting positions of each pump 2 are thus obtained, each having an angular orientation different from its tangential orifice 8.

In general, as a variant, it is possible to provide more than two control units on the plate 20 each occupying a hole 22. These control units may comprise pumps 2, or other equipment used for regulating the circulation of fluids in the vehicle.

1. An assembly comprising several motor vehicle pumps, each pump comprising a body and a rotational axis, the rotational axes of each pump being parallel to each other, and comprising a support member for these pumps, wherein the support member comprises a plate forming a single part arranged in a plane perpendicular to the axes, comprising holes passing through this plate each receiving a body of a pump.

2. The assembly according to claim 1, wherein each hole comprises, in a plane transverse to the axes, a section which is constant over the length of thin the hole.

3. The assembly according to claim 2, wherein the constant section of each hole forms a circle comprising regularly distributed hollows on the contour.

4. The assembly according to claim 1, wherein one face of the plate comprises, on the contour of each hole, grooves each receiving a boss protruding from the outer contour of the bodies of the control units.

5. The assembly according to claim 1, wherein the plate comprises slots for receiving fasteners which have a constant cross section.

6. The assembly according to claim 5, wherein the plate comprises three slots spaced apart from one another.

7. The assembly according to claim 5, wherein the slots form holes that pass through the plate.

8. The assembly according to claim 1, wherein the plate comprises elastomeric materials.

9. The assembly according to claim 8, wherein the plate comprises several elastomeric materials having different stiffnesses.

10. A motor vehicle comprising at least two coolant pumps, wherein the pumps are part of an assembly according claim 1.
